(19) United States
(12) Patent Application Publication
(10) Pub. No.: US 2004/0199488 A1
(43) Pub. Date: Oct. 7, 2004

(54) Web based database inquiry system

(76) Inventors: Kenneth M. Schultz, Davie, FL (US); Jose F. Hernandez, Maimi, FL (US)

Correspondence Address: GREENBERG TRAURIG, LLP, 885 Third Avenue, New York, NY, 10022, US

(21) Appl. No.: 10/665,771

(22) Filed: Sep. 19, 2003

Related U.S. Application Data
(60) Provisional application No. 60/412,247, filed on Sep. 20, 2002.

(51) Int. Cl. G06F 7/00

(52) U.S. Cl. 707/1

(57) ABSTRACT

The Web based Database Inquiry System provides custom tables in which are stored information from an external database. The custom tables are designed to arrange and format the stored information so as to anticipate a user's request thus reducing time and cost associated with retrieving information arranged and formatted as per the user's desire. The information stored in the custom tables are structured, arranged and formatted in typical and a typical approaches derived from ad hoc studies of patterns of user requests for particular applications and/or disciplines. The information is stored in a structured layered fashion and the user is able to retrieve information from the various layers through the use of a “drilling” operation. The custom tables are populated by a process server preferably during times of low database usage by users. The Inquiry System contains modules for different types of information requested by the user and such modules contain the information to be displayed to the user via a browser.

### BACKGROUND OF THE INVENTION

This application claims the benefit of the filing date of a provisional application having serial No. 60/412,247 filed on Sep. 20, 2002.

### FIELD OF THE INVENTION

The present invention generally relates to retrieval of information from databases.

### DESCRIPTION OF THE RELATED ART

Databases are used in vast amounts of applications where multiple parties have simultaneous access to information stored in the database. Often the information retrieved from a database has to be arranged and/or processed in a format that is acceptable to a user of the database or to the entity (person or machine) that retrieved the information. Part of the design of a database includes the categorization and organization of the different types of information stored therein. It may be that when part of or all of the information stored in the database is categorized in a certain manner, specific users of the database would find the categorization advantageous while others may find such a categorization and organization of the information rather burdensome to process. As such the information in a database cannot be arranged in a format that is acceptable to all of the users of the database. Often a user has a certain specific applications for the information stored in the database that requires an a typical arrangement of the information stored in the database. If the information desired by the user is not stored in the a typical arrangement, the user often has to perform additional processing of the information adding time, cost and complexity to the information retrieval process.

In many cases, the user has to generate a set of actions/instructions (e.g., computer program) to arrange information retrieved from a database in an advantageous manner; this has to be done, otherwise the retrieved information would not make any sense to the user. Also, the user may be interested in certain information that are not necessarily stored contiguously in the database or may not be properly categorized by the database. Further, there may exist relationships between certain types of information stored in the database that the user may wish to exploit, but cannot because the database does not indicate or make use of such relationships. Also, often the retrieval of one type of information leads to the need to retrieve other types of information that may or may not be readily available in the database. Even further, two or more different users may need to retrieve the same information at the same time which may lead to an unacceptable delay in the retrieval of such information. All of the above listed issues regarding the retrieval of information often require programming or an elaborate set of instructions to be developed in order to allow one or more user to make use of the information stored in the database. What is therefore needed is a system that allows a user to retrieve information from a database relatively quickly and in a format that is advantageous to the needs of that particular user.

### SUMMARY OF THE INVENTION

The present invention provides a Web based (World Wide Web Internet network) database inquiry system having one or more custom tables where information and/or data stored in one or more external databases can be retrieved relatively quickly because the information and/or data and the particular arrangement of the information and/or data are first stored in the custom tables of the system prior to a user request. The information and/or data stored in the one or more custom tables are processed and are arranged in particular formats and/or physical representations that tend to anticipate specific requests by a user of the external databases. In this manner when a user of the system makes a request for a particular block of information and/or data arranged in a particular manner, the information is retrieved from the one or more custom tables with little or no processing to be done.

The one or more custom tables are specially configured to arrange the data and/or information in typical and a typical fashion so as to anticipate a user's request. The system and method of the present invention populate the custom tables during low usage times to significantly reduce the amount of time it takes to retrieve information from the database. Thus, when a user of the system requests information from the database, the system accesses the already processed information from the one or more custom tables thereby providing the requested information relatively quickly to the user in a manner that anticipates the user's request. The data and/or information stored in the custom tables are stored in various particular arrangements in hierarchical fashion; this allows the custom tables to be “drilled” by a user of the system. The “drilling” operation is the retrieval of information and/or data from information and/or data already being displayed or already provided to a user of the system. Information that is displayed to a user on a display device for example, can be used (e.g., user clicking on displayed text or displayed graphics) to obtain additional information thus generating newly displayed information. One or more pieces of the newly displayed information and/or data can be further drilled to obtain even more information and/or data. In this manner, a user can traverse through layers of information arranged in hierarchical manner in the one or more custom tables. For visual display of information on a display device (e.g., personal computer monitor) the retrieved information and/or data can be displayed textually and/or graphically through the use of a browser.

The information stored in the custom tables are processed by a processing server designed to arrange, format and otherwise process the information stored in the custom tables. The arranged, formatted and processed information are then routed to proper processing system modules for further processing and for representation to a user. The system modules contain a plurality of pages where each page represents a particular configuration (i.e., physical representation) of the processed data. The processed data then appears in textual and/or graphical form when applied to an external browser. Certain pages within a processing system module may have certain special graphics requirements. Such requirements are handled by a graphics server in communication with the processing server and the processing modules. Prior to being applied to the external browser, the type of information to be displayed to a user is checked by a security system module to verify that the information can be shown or displayed to the particular user requesting the information. Various levels of security are defined so that a user will not be able to view certain pages of a module or even information from an entire module if that user does not have the requisite security clearance. Because the custom tables have predefined information and/or data and particular physical arrangements and representations of such information that anticipate requests by a user, there is virtually no real time processing to be done by the processing server or the system processing modules. The system and method of the present invention therefore allows for relatively quick retrieval of various types of information stored in a database. It should be noted, however, that the system does allow a user to retrieve information and/or data from the external databases in various formats and physical representations not anticipated nor provided by the custom tables.

### DETAILED DESCRIPTION

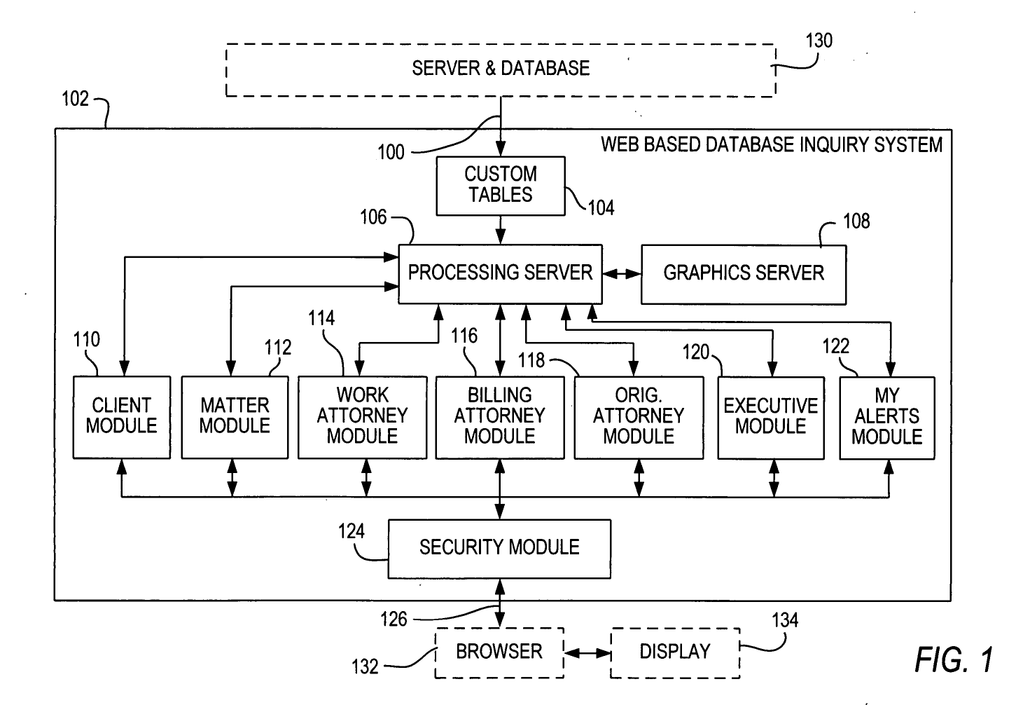

Referring to FIG. 1 there is shown a block diagram of the Web based database inquiry system of the present invention. The components appearing in dashed lines are not part of the present invention; they are shown for illustrative purposes and for ease of explanation of the system and method of the present invention. Procedures (i.e., programs) running on system 102 within processing server 106 retrieve information and/or data stored in the external server and database 130. Preferably, the information and/or data are retrieved during times of relatively low usage by users of the system. The procedures are programmed to populate the custom tables with information and/or data during times when typically the Web based database inquiry system is essentially not being used. For example, several hours after the end of a business day, the information and/or data inputted into the external server and database can be retrieved by the procedures (e.g., computer programs) residing in processing server 106 which are designed to begin accessing information at those particular times of the day. It will be readily understood that the system of the present invention can be designed to have its own database within which information and/or data can be stored in a similar or different manner as external database 130.

The information and/or data are accessed via path 100 and are stored in custom tables 104. The custom table is configured as a plurality of information storage locations. The custom table (104) is designed so that the information and/or data stored therein are arranged in a manner that is likely to be requested by a user of the system. That is, the arrangement of the information and/or data stored in the custom table anticipate the type of information and/or data, the particular arrangement of that information and the particular physical representation that is likely to be requested by a user. It should be noted that the system of the present invention may contain one or more custom table where one custom can be used to store all of the information or a plurality of custom table can be used to store all of the information. The design of custom tables is based on typical representations of information for different applications of the system and method of the present invention. For example, the information and/or data stored in external database 130 can represent financial and/or accounting information typically used by a business entity that sells products and/or provides services. In such a case, a user of the Web based database inquiry system and method of the present invention would desire to see, for example, balance sheets, income statements, inventory records, records of invoices, cash receipts, client ledgers, accounts receivables, account payables and various other types of information.

Additionally, however, the custom tables are designed to provide a typical information or information arranged in a typical formats that can be very useful to users of the system and method of the present invention. These a typical information and/or data and these particular a typical arrangements of information and/or data are based on ad hoc studies of patterns of user requests for particular applications and/or disciplines. Also, groups of users may specify particular information and/or data and particular arrangements of information and/or data and require that these specifications be satisfied by the design of the custom tables. The typical and/or a typical arrangement of information in the custom tables can be configured in hierarchical form where two or more layers of a particular type of information can be stored so that one layer can point to one or more other layers of that information; this allows a user to perform the operation of drilling which allows a user to traverse through various layers of information retrieving and displaying at least part of the stored and processed information. The drilling operation is the ability to retrieve new information that is linked in a hierarchical manner to information currently being displayed. Drilling also includes the ability to retrieve information that is not part of the hierarchy of the information currently being displayed, but is stored in either the custom table 104 or in an accessible server/database such as database 130. The custom table thus allows relatively fast retrieval of the proper type of information for a particular user or application. The information stored in the custom table 104 and in database 130 is retrieved with the use of procedures stored in a processor or server.

The procedures (e.g., computer programs), which can reside in processing server 106, have knowledge about the external database 130 that allows such procedures to retrieve certain types of information and/or data at certain defined location within external database 130 and store such information in the proper locations of the custom table. Processing server 106 manipulates the information and/or data stored in the custom tables (104) to be consistent with the final physical representation of the information and/or data to a requesting user. Processing server 106 can also perform various calculations with the retrieved data to provide additional information to be stored in the custom table and displayed to a requesting user either in textual form, graphical form or any other user discernible form. After having processed the information and/or data, processing server 106 routes the information and/or data to its proper system module for further processing. Processing server 106 routes the information and/or data to the proper system module based on the information type.

The different system modules are designed to process different types of information. A system module is designed to process a certain category of information or type of information. Thus, each system module has stored therein a portion of information arranged and/or formatted as in the custom table 104. All of the layers of the processed information for a particular category of information is thus stored in a corresponding system module; that is, the particular structure and format for a particular category of information is followed by the module. Each system module has at least one page that can be shown on display 134 after such information was transferred to browser 132 via path 126. The system modules shown in FIG. 1 are modules for the particular application of a law firm; that is, when the business entity using the method and system of the present invention is a law firm, the particular set of modules shown could be used. It should be noted, however, that the system and method of the present invention is certainly not limited to the law firm application. The law firm application is used as an example for purposes of explanation of the system and method of the present invention. Any entity, private or public, that uses a database to store different types of information can use the system and the method of the present invention.

Each system module further processes the information and/or data so that it can be viewed by a viewer through a browser software; also additional information and/or data may be generated from the processing performed by one or more module. That is, each system module puts the information and/or data in a format that is compatible with popular browsers such as Internet Explorer and Netscape. A browser is a well known software that translates digital information into text and graphics (also video and audio) that can be viewed on a display device such as a Cathode Ray Tube (CRT) monitor or a Liquid Crystal Display (LCD). Browsers are typically used to view graphics and textual information available on the World Wide Web. The information and/or data received and processed by the modules are arranged as pages; each module has at least one page. Upon request by a user and if the user is allowed to have access to at least one page of a system module, the page is displayed (via path 126 and browser 132) for the user. A page may represent and display data and/or information obtained from one of the layers of the hierarchical arrangement of information and/or data stored in the custom table (104). A page can thus be implemented with a particular block of memory or storage locations. A layer may be displayed using one or more pages. A page can be defined as the information that appears on a screen or the immediate information that can be discerned by a user of the system of the present invention after having performed an information request. An information request can be performed, for example, by a user clicking on information already being displayed by the system of the present invention. The information is then retrieved with little or no processing.

A user can click on a particular piece of information displayed on a page and obtain newly displayed information on a new page. Further, a user can click on information or data on the newly displayed page to obtain other information. Thus, it is in this manner that a user can “drill” for information and/or data hierarchically stored in the custom tables. Certain displayed information when drilled may not cause information to be retrieved from the custom table 104, but may cause the system to retrieve the information from the external database 130 and cause the servers (106, 108) and the modules (110-122) to process the retrieved information at the time of the request.

The system modules also process the information and/or data so that the proper data and/or information appear in their proper pages. A page may have specific graphical requirements that require the use of a dedicated graphics server such as server 108. The user while viewing a page may “click” on a virtual button to request certain graphs. The user request is passed on to processing server 106 which passes the request and any other necessary data and/or information to Graphics server 108 to allow Graphics server 108 to generate the requisite graphical representation. For example, various pie charts, bar charts and other graphical representation of data can be generated by Graphics server 108. Also, the retrieval of certain pages from certain system modules may automatically trigger a request to use Graphics server 108. It will be understood that processing server 106 may also have graphic capabilities and thus can, in some circumstances, generate graphic information without having to use Graphics server 108.

A user is able to view one or more pages associated with a particular system module by entering that module. Before, the method and system of the present invention allows one or more pages from the system module to be transferred to an external browser, the user is checked for security clearance. Security module 124 verifies whether the user is allowed to view the page or even the contents of an entire system module. The user, prior to having been given an opportunity to enter the available modules, is put through an authentication process that first determines whether the user is authorized to use the system and (2) the level of security clearance associated with that user which defines specifically which system modules and/or which pages within certain system modules are not accessible to the user. One example of an authentication process is the system requesting that the user enter a password or keyword before the user is given access to a page or to an entire set of pages of a layer of a system module or even to an entire system module.

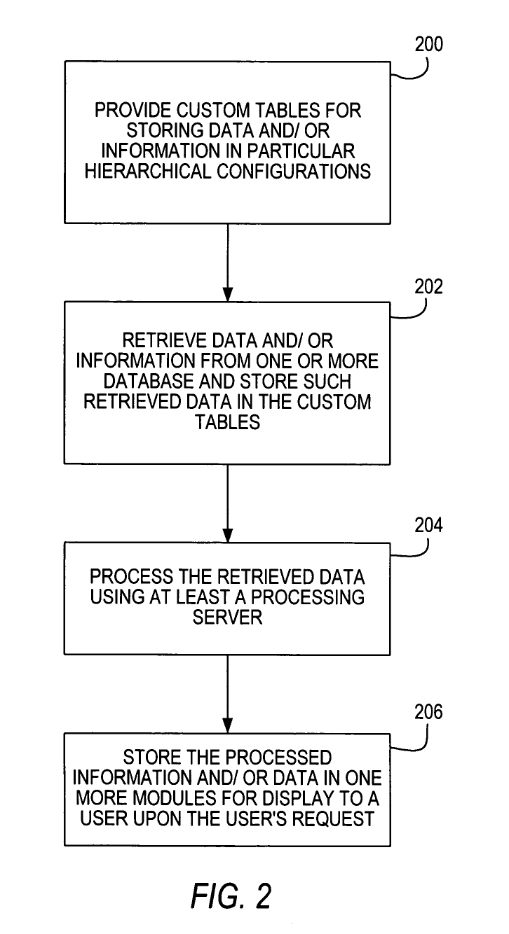

Referring now to FIG. 2, there is shown the method of the present invention. In step 200, custom tables are provided for storing information and/or data in particular arrangements and physical representations that constitute a hierarchical structure. Each layer of the hierarchical structure can be accessed from the next higher layer or the previous lower layer. The particular arrangements in the custom table are based on the particular application for which the system and method of the present invention is being used. The particular arrangements are also based on ad hoc analysis of patterns of user requests; thus the particular arrangements of information and/or data anticipate a user's request. Different custom tables can be provided for different applications.

In step 202, the data and/or information stored in one or more of the databases are retrieved and stored in the custom tables. Procedures stored in the processing server retrieve certain data and/or information from certain locations in the databases. Particular data and/or information retrieved from the databases are associated with particular locations in the custom tables. The processing server is able to store the data and/or information in the proper locations of the custom table.

In step 204, the data stored in the custom tables are processed by a processing server. The processing server groups or arranges certain data for storage in system modules. Certain pieces of data and/or information or certain groups of data and/or information are associated with particular locations in certain system modules having a particular information structure and format. The processing server may also use a graphics server with which it is in communication to generate additional graphic information.

In step 206, the processed information and/or data is stored in one or more system modules. The processing server routes the processed information and/or data to their proper modules. The information and/or data are stored in pages. Each system module has at least one or more pages that are displayed upon a user's request. Each system module is associated with a particular type of information; that type of information is stored as per the structure (or format) of the custom table. The structured information is thus processed and the resulting processed structured information is stored in various associated modules. The modules may perform additional processing on the information. Any information generated from such processing is also stored as per the arrangement dictated by the custom table for that type of information.

The system and method of the present invention is further explained in the context of a database having accounting and financing data for the operation of a law firm where the external database is a server called CMS Open™. The law firm application is only an example of one particular way in which the method and system of the present invention can be used. The law firm application version of the method and system of the present invention is referred to as LAWDRILL™. The following sections describe the various aspects of the LAWDRILL™ system.

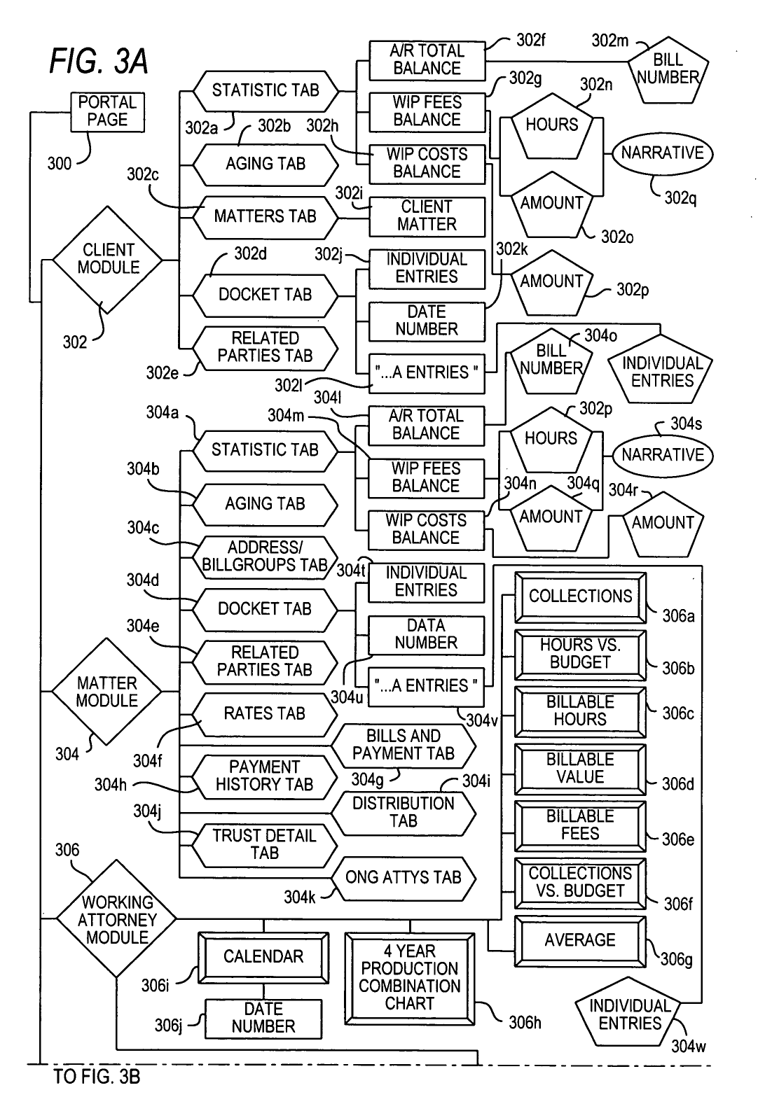

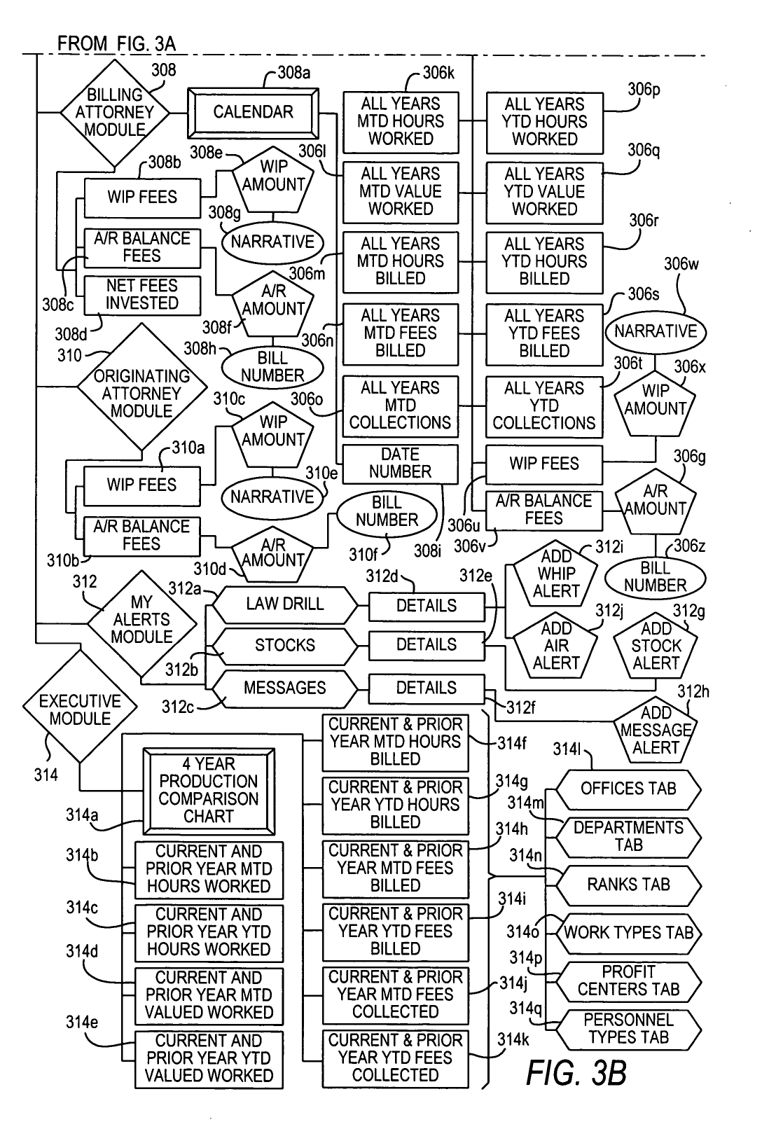

Referring now to FIG. 3, there is shown the various types of information that can be retrieved and how these types of information are arranged in the custom table. Each type of information has at least one layer of information and in most cases each information type has several layers of information. Each layer of information comprises one or more blocks of information which can be retrieved from the preceding layer or the successive layer. In the law firm application, there are seven (7) information types which are the Client module Type (302), the Matter module Type (304), the Working Attorney module Type (306), the Billing Attorney module Type (308), the Originating Attorney module Type (310), the My Alerts module Type (312) an the Executive module (314) Type. It should be noted that the module types shown in FIG. 3 are the actual information grouping and the modules shown in FIG. 1 are part of a system and they represent the actual physical location or implementation of a device or memory location within which the information groupings are stored. Thus, for example, the Client module Type (302) is stored in system module 110 of FIG. 1. Similarly, Matter module Type 304 is stored in system module 112 of FIG. 1, Working Attorney module Type 306 is stored in system module 114, Billing Attorney module Type 308 is stored in system module 308, Originating Attorney module Type 310 is stored in system module 118, Executive module Type 314 is stored in system module 120 and My Alerts module 312 is stored in system module 122. All of the information types can be initially entered through a portal page 300 which when implemented on a computer is an initial screen that displays the various information types. The user can then click on any one of the seven information types to request various information from that information type.

Client Module type 302 is shown as having four layers of information. The information is generally associated with data for clients of a law firm. The first layer comprises tabs 302a-302e. Tabs 302a is called a Statistics tabs which provides basic client statistics such as client name, open date for the client (date of acceptance of entity as a client), status of the client (e.g., active or non-active), responsible and billing attorneys for the client. Tabs 302a also contains accounting statistics for the client such as current YTD (year to date) and LTD (Lifetime to date) fees and costs, A/R (accounts receivables), WIP (Work In Progress), Billings, Collections, Write-offs, Credits and current value of hours worked and billed. Tab 302b is called the Aging Tab which contains separate A/R and WIP aging tables of fees, costs and other amounts and totals using standard aging buckets with corresponding charts. Tab 302c is called the Matters which contains a listing of active matters for the client including matter number and name, A/R fees, costs, other amounts and total amounts, WIP fees and costs, credits, retainer and trust amounts. Tab 302d is called the Docket Tab which contains a current month calendar view of docket entries. Tab 302e is called the Related Parties Tab which contains a list organized by matter of related party names and statuses. A user can drill information for information in the second layer by clicking on an appropriate displayed information from the first layer. The second layer contains information blocks 302f-302l.

Blocks 302f (A/R Total Balance), 302g (WIP Fees Balance) and 302h (WIP Costs Balance) can be reached by drilling the appropriate displayed information of the Statistics tab 302a. Block 302i can be reached by drilling the appropriate displayed information of Matter Tab 302c. Blocks 302j (Individual entries), 302k (Date Number) and 302l (“ . . . #Entries”) can be reached by drilling the appropriate displayed information of Docket Tab 302d. Block 302l can be further drilled to reach a third layer block called “Individual Entries.” Other third layer blocks include a block called “Bill Number” (302m) which can be reached by drilling the appropriate displayed information on block 302f. Hours block (302n) and Amount block (302o) can be reached by drilling the appropriate displayed information of block 302g. Amount block 302p can be reached by drilling the appropriate displayed information of block 302h. A fourth layer block called “Narrative” (302q) can be reached by drilling the appropriate displayed information of either blocks 302n or 302o.

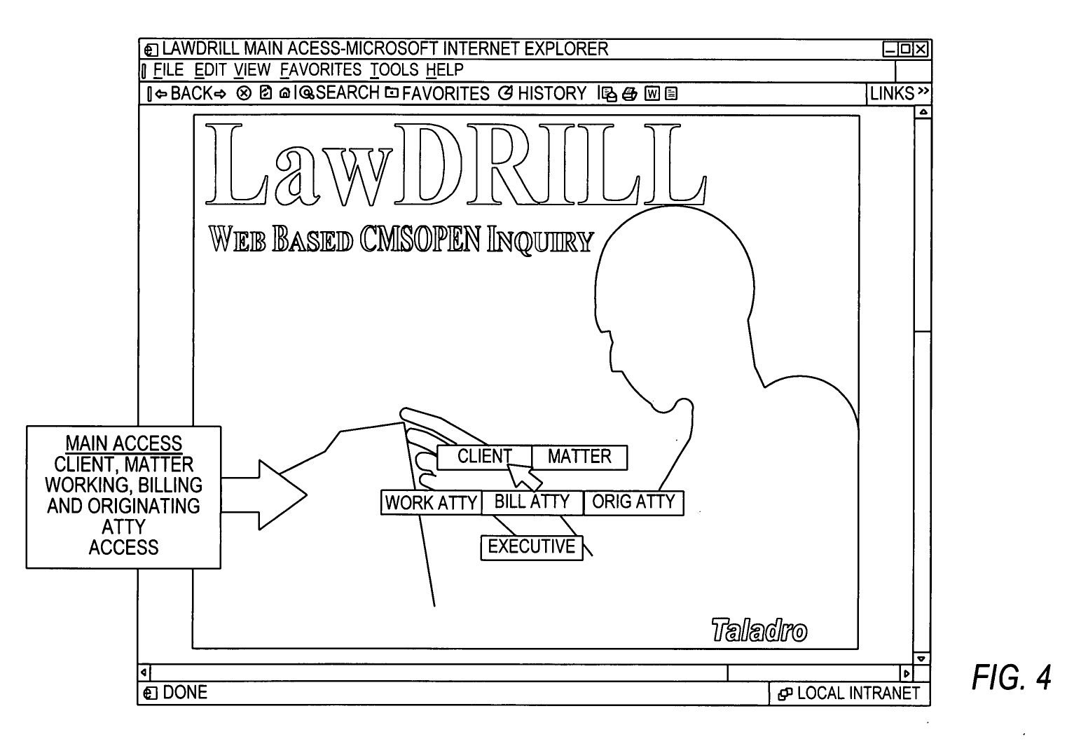

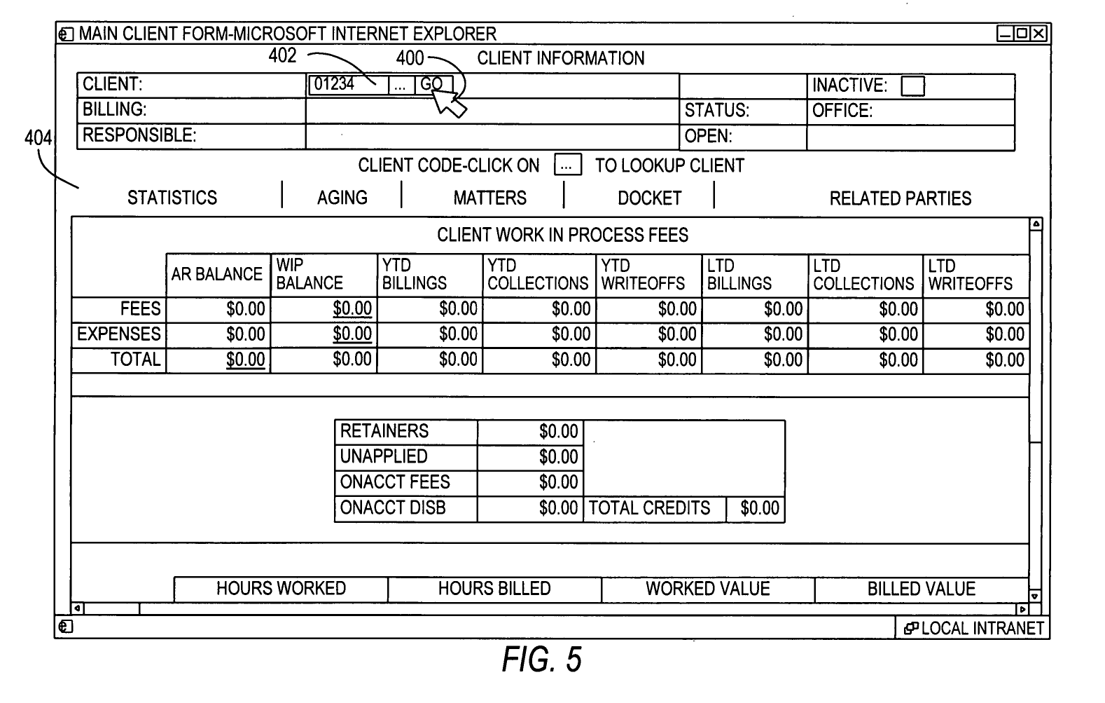

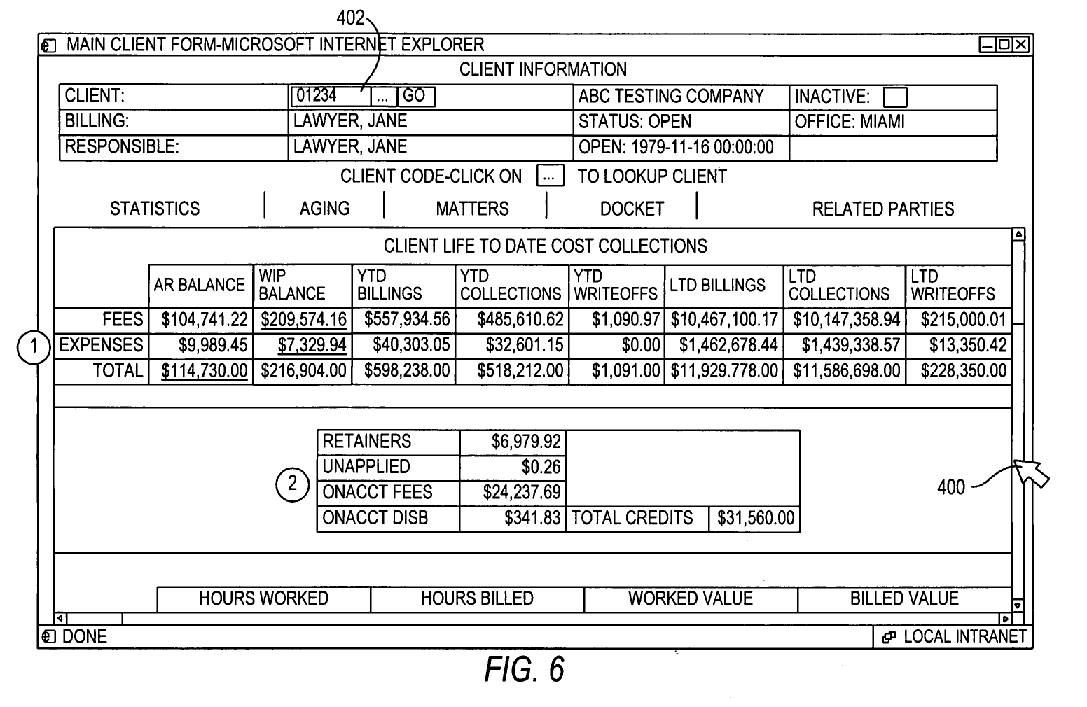

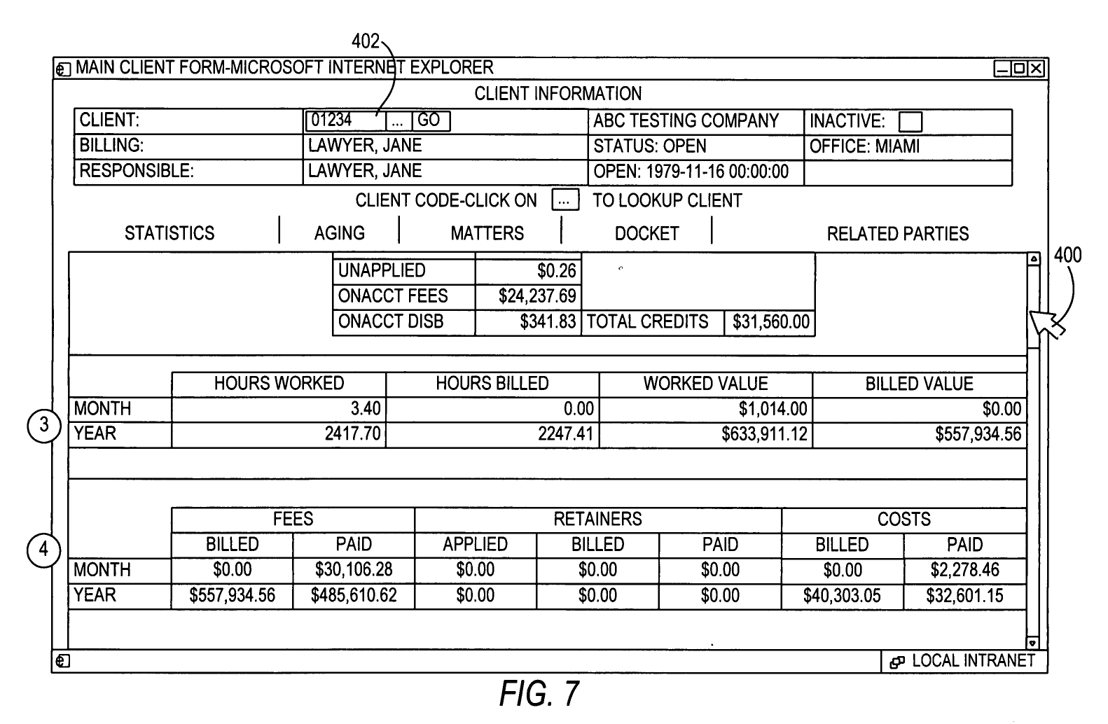

FIGS. 4-16 show a particular GUI (Graphics User Interface) implementation of the method and system of the present invention. For ease of explanation and brevity, the implementation will describe the design of the Client system module 110 (shown in FIG. 1) within which various client module type information 302 (see FIG. 3) are stored. The other modules are similarly implemented. FIG. 4 shows the portal page displaying and providing to the module types. Cursor 400 is positioned on the Client module virtual button as shown in FIG. 4. The user clicks on the Client module virtual button to enter and gain access to the client module information as shown in FIG. 5. The Statistics Tab 404 is selected. A number associated with the client is entered in field 402 and the “Go” virtual button is pressed with cursor 400 leading to a display depicted by FIGS. 6 and 7. Chart 1 (FIG. 6) displays various information characterized as either fees or expenses and their total. Chart 2 (FIG. 6) shows Retainer amounts, Unapplied amounts, On Acct Fees, On Acct Disbursements and Total amount of credits. Chart 3 shows hours worked, hours billed, worked value and billed value on monthly and yearly bases.

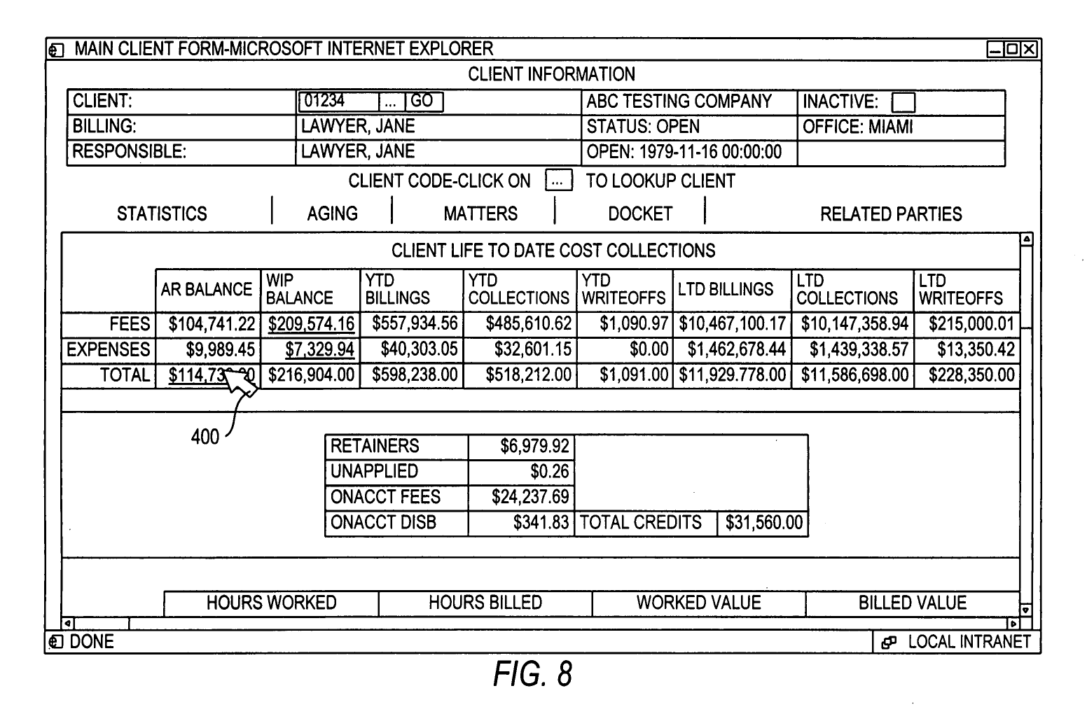

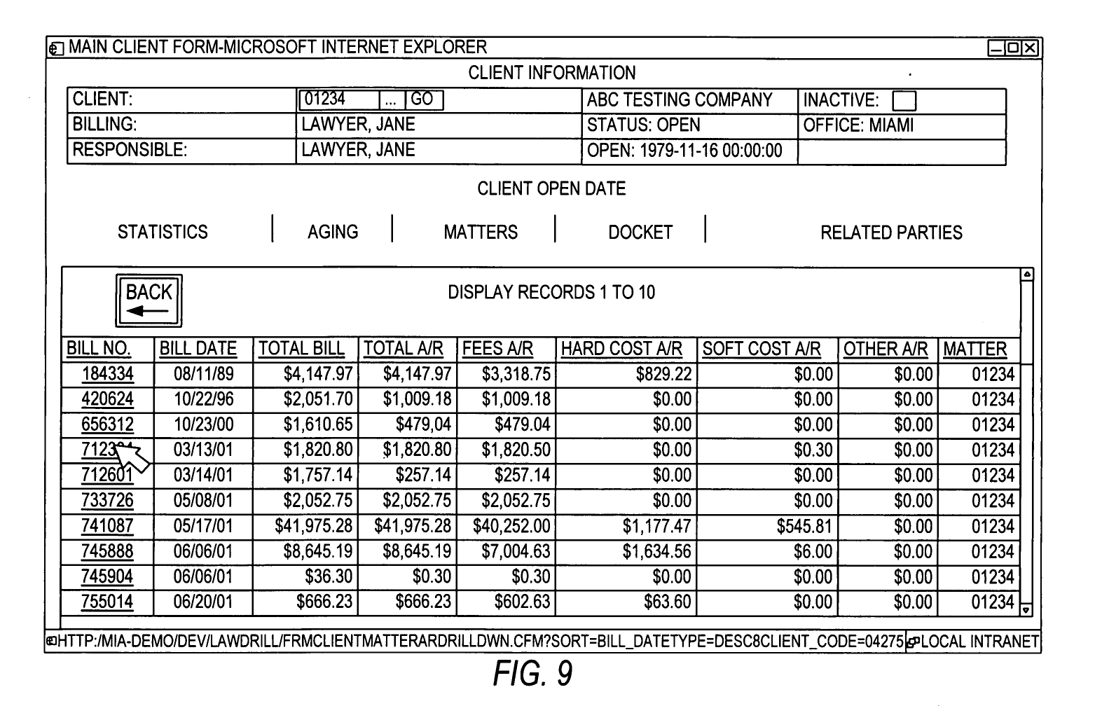

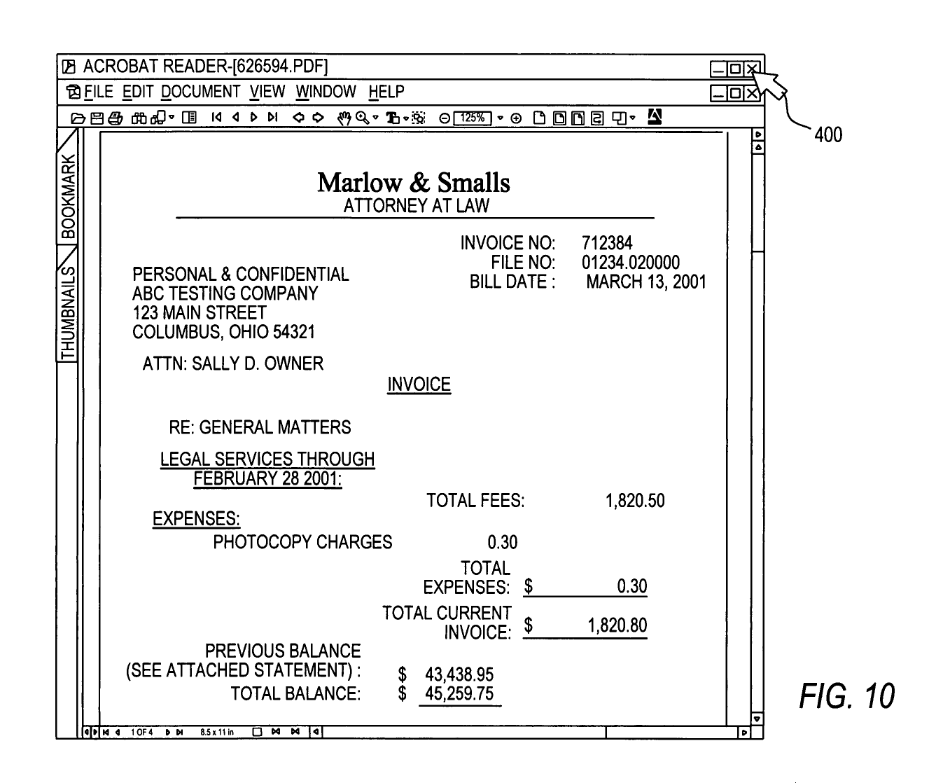

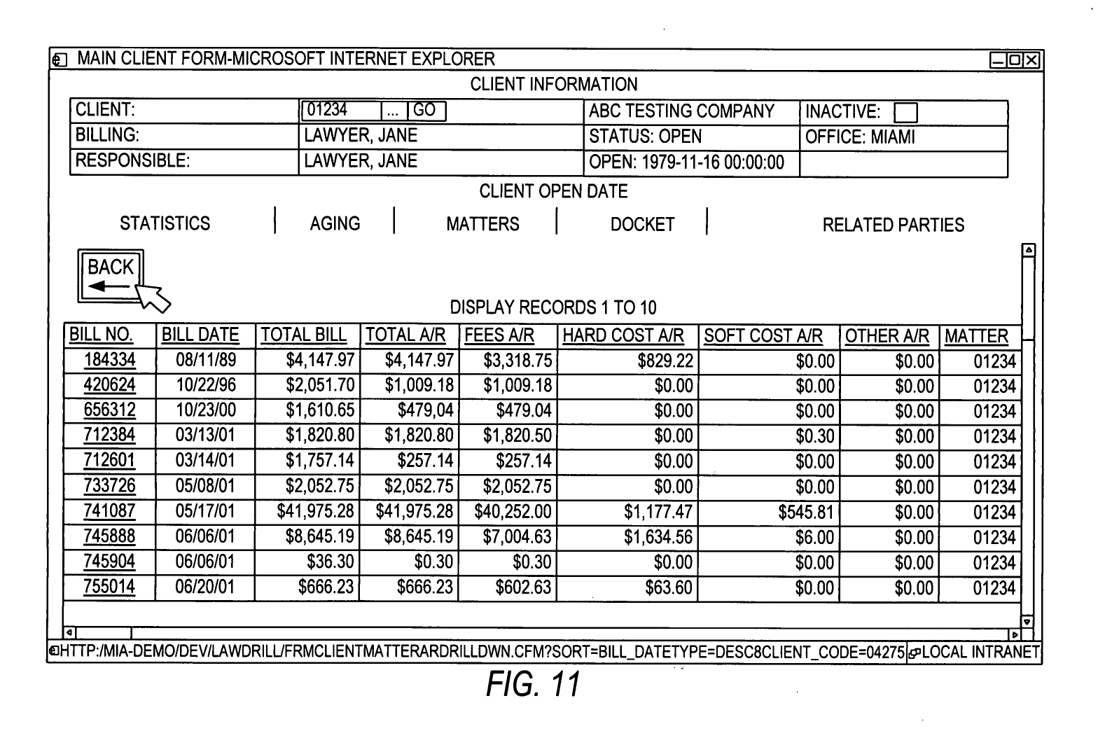

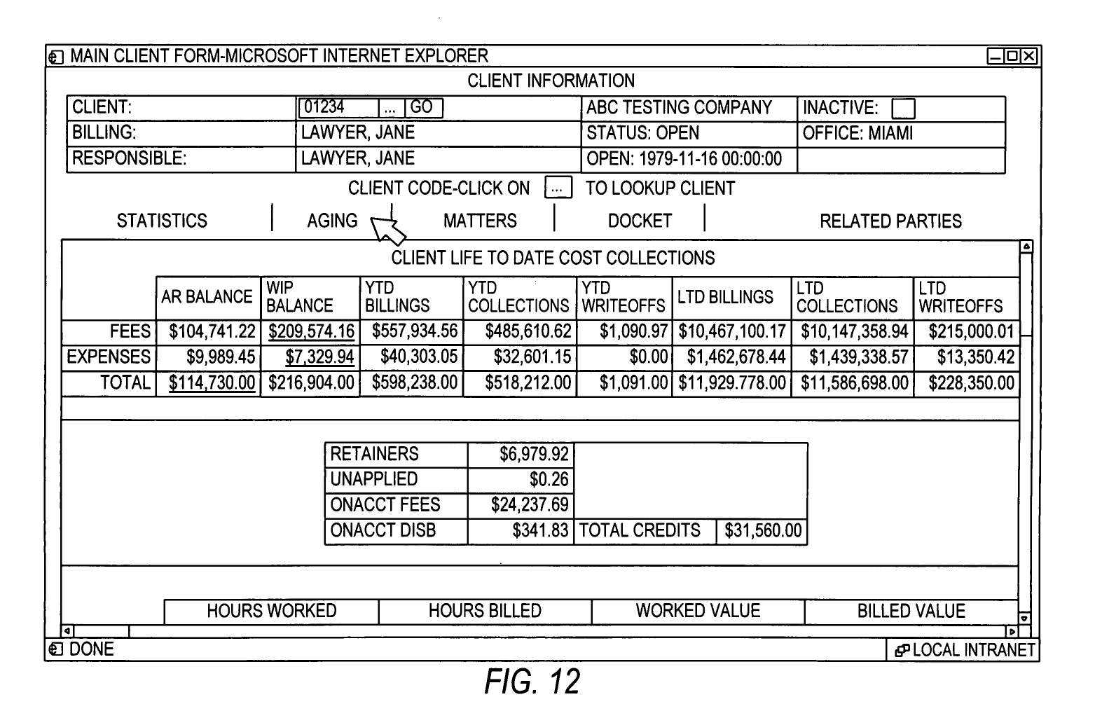

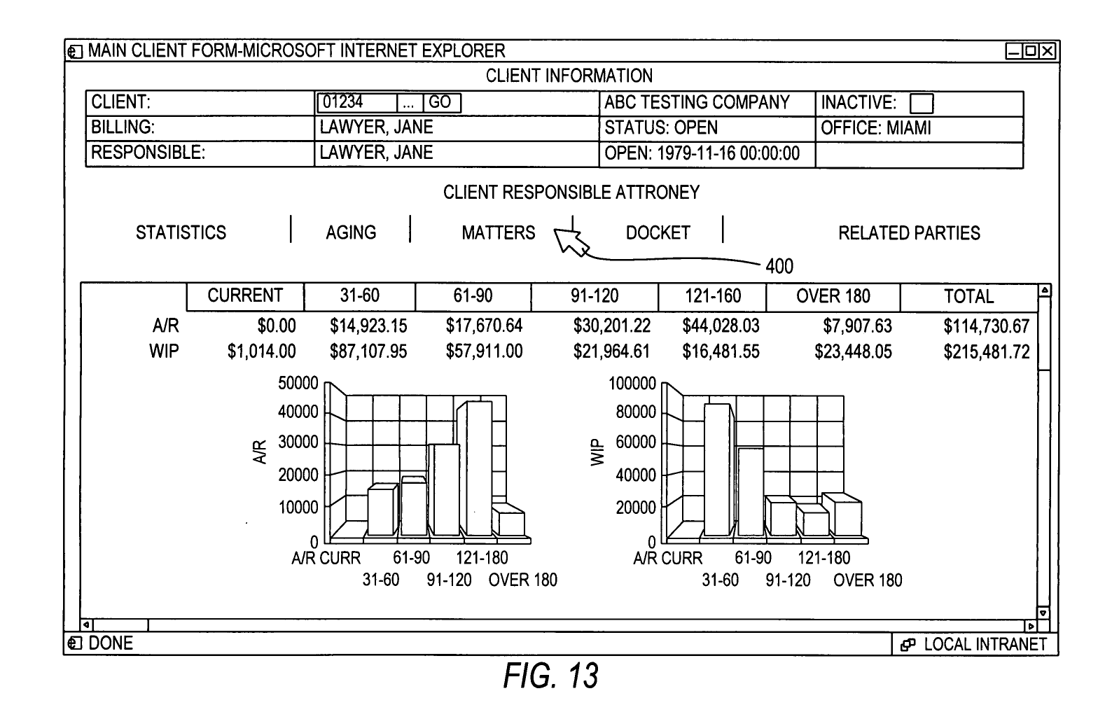

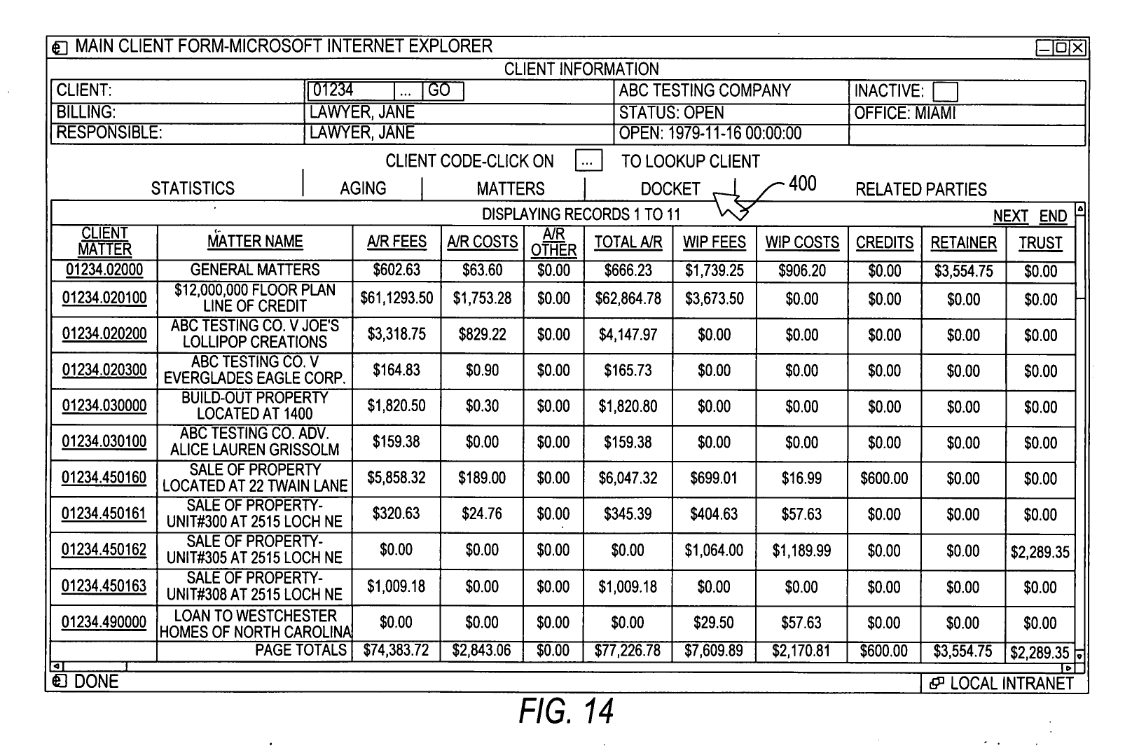

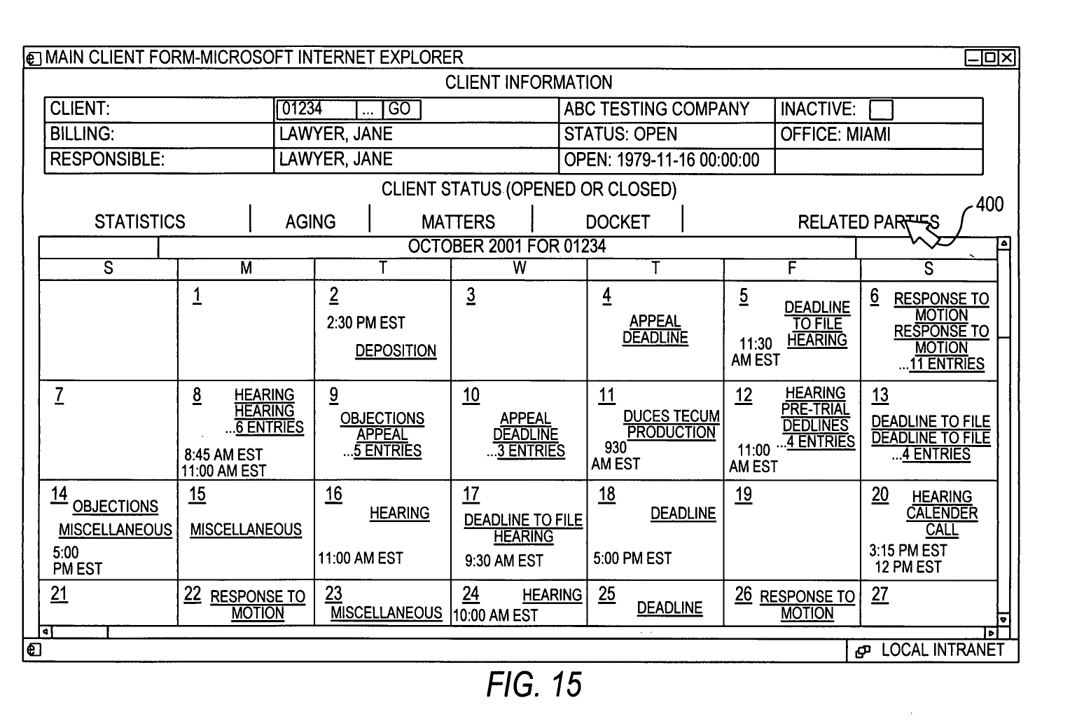

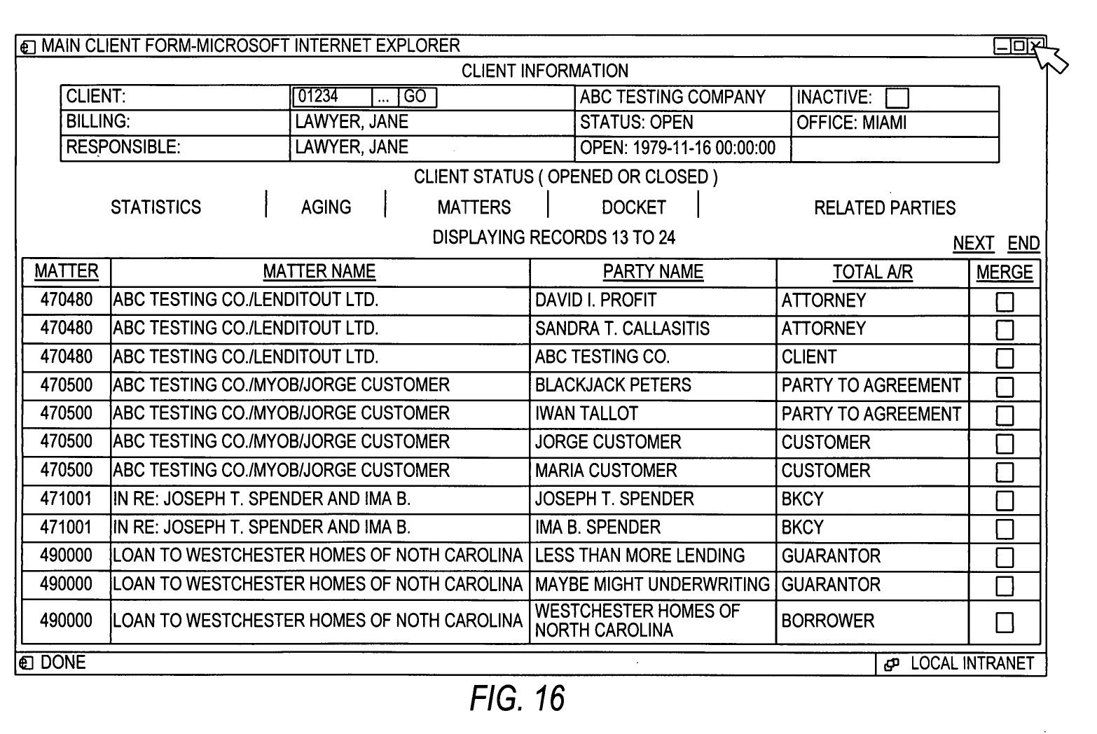

Referring now to FIG. 8 and as discussed with respect to FIG. 3, the A/R Balance Total block 302f can be drilled to yield Bill number block 302m; this is shown in FIG. 8 where the cursor 400 is positioned on A/R Balance Total to drill for Bill Number information block (302m of FIG. 3). The Bill numbers for the client and associated information are shown in FIG. 9. Cursor 400 is positioned over bill number 712384 and the user clicks on that bill number to drill for a PDF (______) version of the actual bill as shown in FIG. 10. The display shown by FIG. 10 can be deleted as shown yielding a display shown by FIG. 11 returning to the list of Bill numbers any one of which can be drilled. A back button can allow the user to return to the first layer where the user can drill the Aging Tab (302b in FIG. 3). FIG. 12 is the result of pressing the back button and cursor 400 is positioned on the Aging Tab leading to a display shown by FIG. 13. FIG. 13 shows various color coded bar charts of A/R and WIP aged over a six month period. The cursor 400 is positioned over the Matters Tab and is clicked to lead to the display shown in FIG. 14 showing various details of the matters associated with the client. Any one of the listed matters can be drilled to obtain information about the drilled matter. From the Matters Tab display, the cursor can be positioned over the Docket Tab and is clicked to lead to the display shown in FIG. 15. FIG. 15 a graphical representation of all matters docketed for a certain month for the client. Any one of the docketed matters can be drilled to obtain more specific information about the docketing of such matters. While in the Docket Tab, the cursor 400 can be positioned over the “Related Parties” tab to yield to the display shown in FIG. 16. FIG. 16 is a list of matters and their related party names and statuses.

As previously stated the other modules are similarly implemented. For example, the Matter module 304 is also shown as having three layers. The first layer comprises Statistics Tab (304a), Aging Tab (304b), Address/Billgroups Tab (304c), Docket Tab (304d), Related Matters Tab (304)e, Rates Tab (304f), Bills and Payments Tab (304g), Payments History Tab (304h), Distributions Tab (304i), Trust Detail Tab (304j) and Originating Attorneys Tab (304k). Statistics Tab 304a can be drilled to lead to the second layer comprising A/R Total Balance type 3041, WIP Fees Balance type 304m and WIP Costs Balance type 304n. Module type 304l can be drilled to lead to Bill Number type 304o. Module type 304 304m can be drilled to lead to Hours (304p) and Amount (304q) both of which can be drilled to lead to Narrative type 304s. Docket Tab 304d can be drilled to reach blocks Individual Entries 304t, Date Number block 304u and “ . . . #Entries” block 304v. Block 304v can be drilled to obtain Individual Entries Block 304w.

Working Attorney Module 306 is shown as having two layers. The first layer consisting of Collections block 306a, Hours vs. Budget block 306b, Billable Hours block 306c, Billable Value block 306d, Billed Fees block 306e, Collections vs. Budget block 306f, Averages block 306g, 4-year Production Comparison Chart 306h and Calendar block 306i. The Calendar block can be drilled to reach Date Number block 306j. Working Attorney module also has blocks 306k-306v for various fees billed, Value Worked, Collections and other fees as a second layer. A third layer comprising A/R Amount block 306y and WIP Amount block 306×. The third layer blocks can be drilled to reach Narrative block 306w and Bill Number block 306z. Billing Attorney module type 308 also shows three layers of different types of information blocks. One set of information blocks in the first layer comprises WIP fees block 308b, A/R Balance Fees block 308c, and Net Fees Invested Block 308d. Block 308c can be drilled to reach A/R Amount Block 308f which can be drilled to reach Bill Number block 310f. Block 308b can be drilled to read WIP Amount block 308e which can be drilled to reach Narrative block 308g. There is also another first layer block 308a (Calendar block) which can be drilled to reach Date Number block 308c.

Originating Module 310 has three layers. The first layer comprising WIP Fees block 310a and A/R Balance Fees block 310b. Block 310a can be drilled to reach the second layer block 310c WIP Amount which can be drilled to reach Narrative block 310e. Block 310b can be drilled to reach A/R Amount block 310310d which can be drilled to reach third layer Bill Number block 310f. My Alerts module 312 also has three layers where the first layers comprises LAWDRILL block 312a, Stocks block 312b and Messages block 312c. Blocks 312a, 312b, and 312c can be drilled to reach Details blocks 312d, 312e and 312f respectively. Block 312d can be drilled to reach Add a WIP Alert block 312i and Add An A/R Alert block 312j. Block 312e can be drilled to reach Add A Stock Alert block 312g. Details block 312f can be drilled to reach Add A Message Alert 312h. Unlike the other module types, the My Alerts Module contain information in which a particular user might be interested; it is used as a module containing information that is personal to a particular user. The Executive Module 314 provides global summary information for clients and attorneys. Typically, the pages of the Executive module are not accessible to many users of the system. Usually only certain designated attorneys in the law firm (e.g., Managing Attorney) are given authorization to view pages from the Executive module. The Executive module has a first layer comprising blocks 314a-314k any one of which can be drilled to reach second layer block 314l-314q. Although not shown, the second layer blocks can be drilled to reach other blocks in other layers.

We claim:

1. A Web based database inquiry system comprising:
at least one custom table for storing information and/or data in a hierarchical format;
at least one processing server that retrieves data and/or information from one or more databases and stores the data and/or information in the at least one custom table; and
at least one processing module for storing data and/or information from the at least one custom table in a hierarchical page format for display via a browser.

2. A method for retrieving and storing data and/or information from one or more databases, the method comprising the step of:
providing at least one custom table for storing data and/or information in a hierarchical manner where such data and/or information are accessed from the one or more databases by a processing server and which data and/or information after having been processed by the processing server are stored in one or more pages of at least one processing module for display via a browser.
